(19) United States
(12) Patent Application Publication
(10) Pub. No.: US 2008/0306955 A1
(43) Pub. Date: Dec. 11, 2008

(54) Content management system and method

(75) Inventors: Sajani Geria, East Brunswick, NJ (US); Hood Qa'lm-maqami, Montclair, NJ (US); Wayne G. Marcy, JR., Ocean, NJ (US)

Correspondence Address: MORGAN, LEWIS & BOCKIUS LLP, 1701 MARKET STREET, PHILADELPHIA, PA, 19103-2921, US

(73) Assignee: Lehman Brothers Inc., New York, NY (US)

(21) Appl. No.: 12/079,405

(22) Filed: Mar. 26, 2008

Related U.S. Application Data
(60) Provisional application No. 60/920,080, filed on Mar. 26, 2007.

(51) Int. Cl. G06F 17/30

(52) U.S. Cl. 707/9; 707/E17.014

(57) ABSTRACT

A method and system for facilitating the editing by a user of content hosted on a network. A page comprising one or more items of content is presented to the user. A tag is embedded in the page. The tag includes rules associated with an identity of users who are entitled to edit one or more of the content items. If the user is entitled to edit one or more of the content items, an indication is presented to the user on the page. When activated by the user, the indicator allows the user to edit one or more of the content items.

This application claims priority to U.S. Provisional Patent Application No. 60/920,080 filed Mar. 26, 2007, which is hereby incorporated by reference herein.

### BACKGROUND OF THE INVENTION

Dissemination of information throughout organizations is largely accomplished by posting of such information on an organization's intranet. For many organizations, the information to be disseminated is ever-changing, thereby making an organization's intranet a dynamic environment. Even in organizations with extensive information technology support services, it is efficient to allow non-technical employees to be able to make their own changes to intranet content. However, there must be control over the extent to which such changes can be made. Thus, there is a need for a method and system that allows non-technical personnel to make changes to content hosted on a network, subject to appropriate management and controls.

### FIELD OF THE INVENTION

This invention relates to managing content that is displayed on electronic pages hosted on a network.

### SUMMARY OF THE INVENTION

The present invention is directed to a method and system for facilitating the editing by a user of content hosted on a network. A page comprising one or more items of content is presented to the user. A tag is embedded in the page. The tag includes rules associated with an identity of users who are entitled to edit one or more of the content items. If the user is entitled to edit one or more of the content items, an indication is presented to the user on the page. When activated by the user, the indicator allows the user to edit one or more of the content items.

### BRIEF DESCRIPTION OF THE DRAWINGS

The accompanying drawings, wherein like referenced numerals are employed to designate like parts or steps, are included to provide a further understanding of the invention, are incorporated and constitute a part of this specification, and illustrate embodiments of the invention that together with the description serve to explain the principles of the invention.

In the drawings:

FIG. 1 show an exemplary page that includes an edit button;

FIG. 2 is an exemplary system that may be used in connection with the present invention;

FIG. 3 depicts an exemplary edit button tag;

FIG. 4 provides example of the processor replacing the edit button tag with a tag that allows for editing of the content;

FIG. 5 provides a portion of an exemplary database schema that may be used in connection with implementing the present invention; and

FIG. 6 is a flow chart showing an exemplary method of the present invention.

### DESCRIPTION OF THE INVENTION

The content management system described herein allows non-technical business users to easily develop and update pages hosted on a network (e.g., internet or intranet). Users are given the ability to update content while viewing the content from a portal, rather than an application interface. By giving content developers two entry points to update content, flexibility is provided, therefore saving them time and effort.

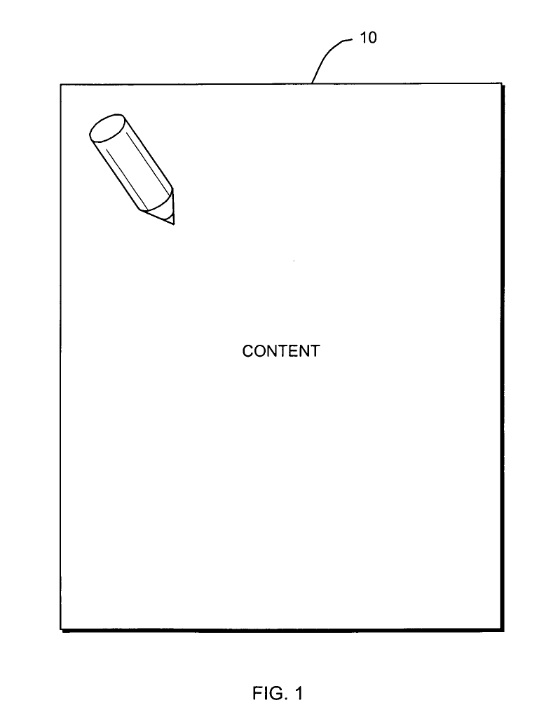

Folders are used to separate content and enforce permissions. Users have the ability to create multiple folders and attach editor and viewership permissions to those folders. All content is therefore stored in a single folder with a pre-defined set of editors. The edit button 10 (i.e., the indicator that allows for editing of a page) is therefore rendered only for the pre-defined list of editors for that particular page, as shown in FIG. 1.

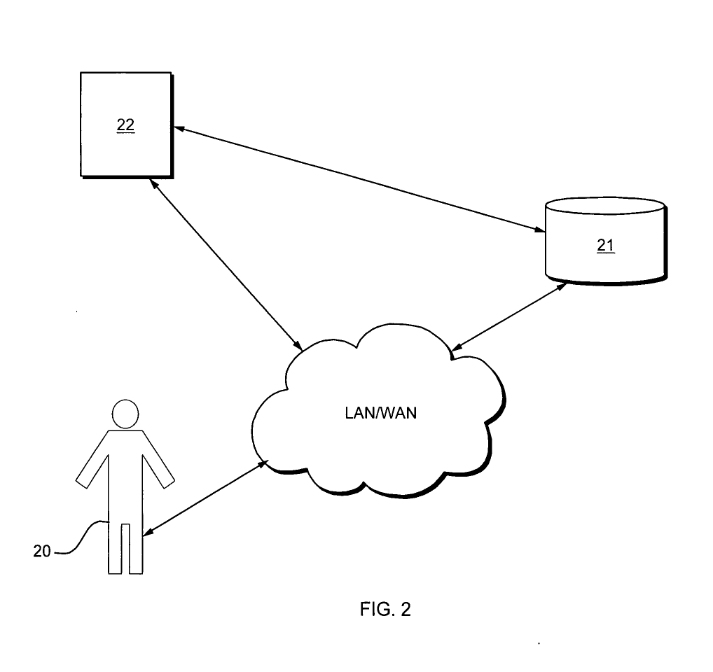

With reference to FIG. 2, when users 20 create new content, each piece of content is registered as a separate nugget/portlet in a database 21. When each nugget is registered in the database 21, the list of users who have edit rights to that piece of content is also registered within the database 21.

Composite pages are rendered by a processor 22. When content is published, a special tag is added that lets the processor 22 know where to place the edit button for permissioned users. When the processor 22 renders developed content, it looks for this special edit button tag; for permissioned users, this tag is replaced with the edit button icon which links to editing screens.

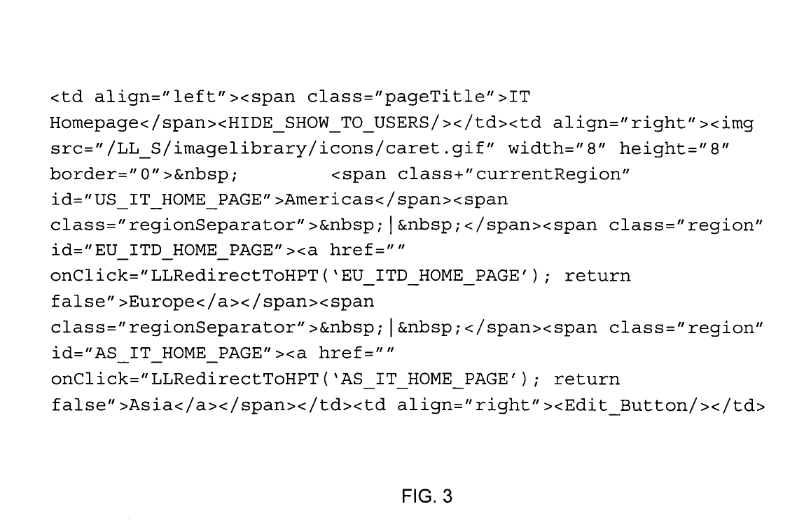

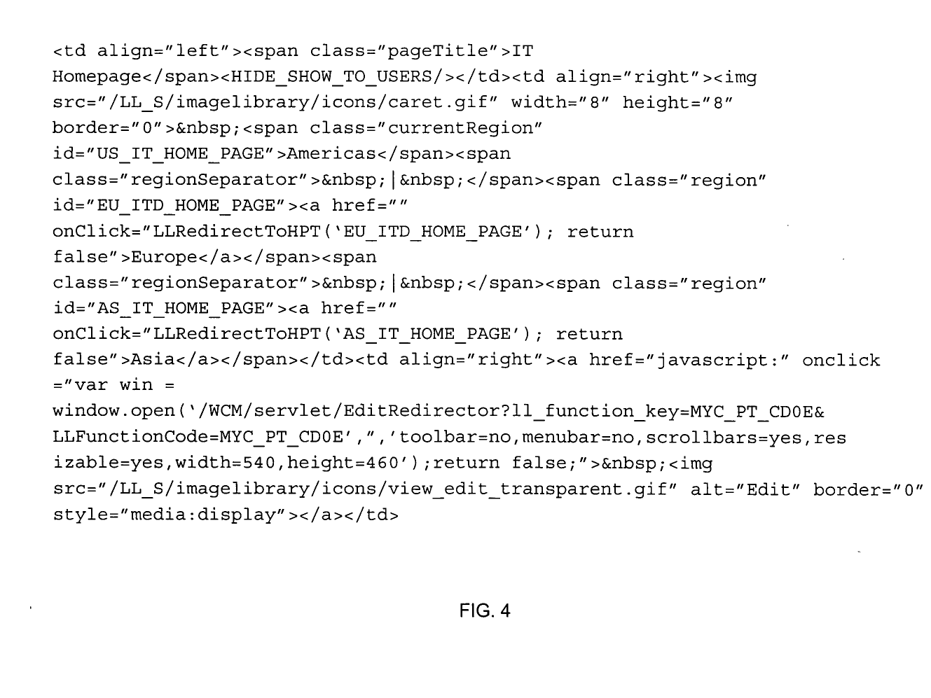

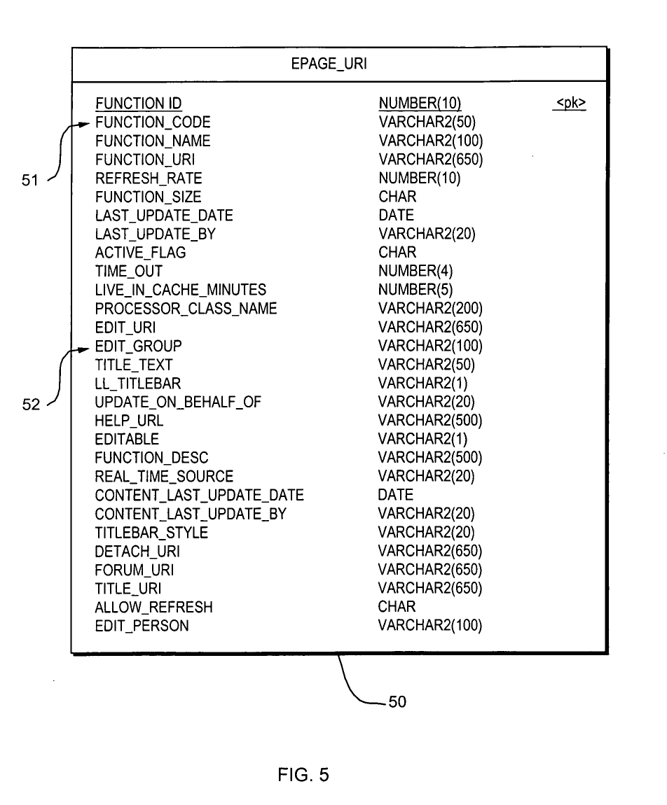

FIG. 3 provides an example of the edit button tag that may be added. FIG. 4 provides example of the composite page builder replacing the edit button tag with the actual edit button icon which allows permissioned users to link to editing screens. FIG. 5 depicts one table 50 from an exemplary database schema that may be used in connection with implementing the present invention. FUNCTION_CODE 51 denotes the code for the item that can be edited. EDIT_GROUP 52 denotes which user or user group can edit the particular item.

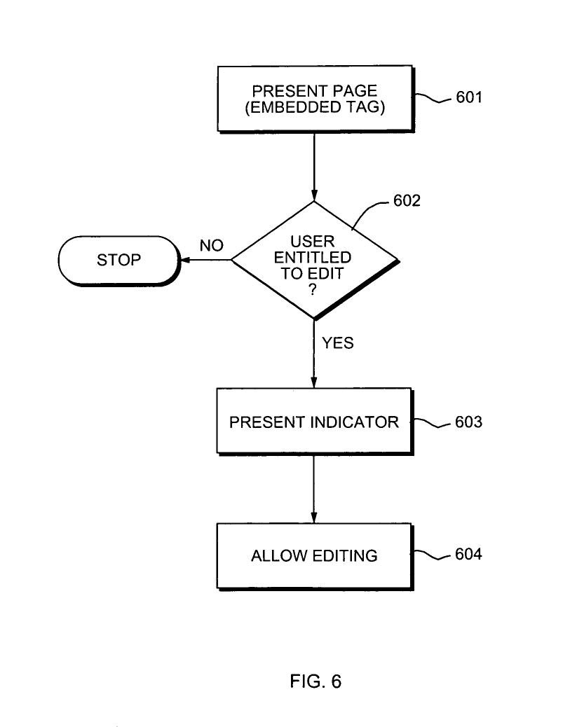

FIG. 6 is a flow chart, illustrating an exemplary method of the present invention for facilitating editing by a user of content hosted on a network. In step 601, a page is presented to the user by a processor. The page includes one or more items of content stored in one or more databases. A tag is embedded in the page and comprises rules associated with an identity of one or more users who are entitled to edit one or more of the one or more items of content. In step 602, it is determined whether the user is entitled to edit one or more of the one or more items of content. If so, in step 603, an indicator is presented to the user on the page by the processor; when activated by the user, in step 604, the indicator allows the user to edit one or more of the one or more items of content.

The present invention is intended to embrace all alternatives, modifications and variances that fail within the scope of the appended claims.

What is claimed is:

1. A computer-implemented method for facilitating editing by a user of content hosted on a network, the method comprising:
(A) presenting a page to the user via a user interface, the page comprising one or more items of content stored in one or more databases, wherein a tag is embedded in the page and comprises rules associated with an identity of one or more users who are entitled to edit one or more of the one or more items of content; and
(B) if the user is entitled to edit one or more of the one or more items of content, presenting an indicator to the user on the page via the user interface;
wherein, when activated by the user, the indicator allows the user to edit one or more of the one or more items of content.

2. A system for facilitating editing by a user of content hosted on a network, the system comprising:
one or more databases that store information comprising page content information associated with user identity information, the user identity information comprising an identity of one or more users entitled to edit the associated page content information; and
a processor that renders one or more electronic pages,
wherein, in connection with the rendering, the processor reviews a tag embedded in at least one of the one or more electronic pages comprising rules associated with an identity of one or more users entitled to edit page content information associated with the at least one of the one or more electronic pages; consults the database to determine the identity of the one or more users entitled to edit the page content information associated with the at least one of the one or more electronic pages; and allows the one or more entitled users to edit the page content information.

3. A computer-readable medium comprising instructions which, when executed by a processor, cause the processor to perform a method for facilitating editing by a user of content hosted on a network, the method comprising:
(A) presenting a page to the user via a user interface, the page comprising one or more items of content stored in one or more databases, wherein a tag is embedded in the page and comprises rules associated with an identity of one or more users who are entitled to edit one or more of the one or more items of content; and
(B) if the user is entitled to edit one or more of the one or more items of content, presenting an indicator to the user on the page via the user interface;
wherein, when activated by the user, the indicator allows the user to edit one or more of the one or more items of content.
